(19) United States
(12) Patent Application Publication
(10) Pub. No.: US 2013/0293527 A1
(43) Pub. Date: Nov. 7, 2013

(54) DISPLAY DEVICE, METHOD OF DRIVING DISPLAY DEVICE, AND ELECTRONIC APPARATUS

(71) Applicant: SONY CORPORATION, Tokyo (JP)

(72) Inventor: Tetsuo Minami, Tokyo (JP)

(73) Assignee: Sony Corporation, Tokyo (JP)

(21) Appl. No.: 13/860,963

(22) Filed: Apr. 11, 2013

(30) Foreign Application Priority Data
May 2, 2012 (JP) 2012-105250

(51) Int. Cl. G09G 3/30

(52) U.S. Cl. CPC G09G 3/30
USPC 345/212; 345/204; 345/76

(57) ABSTRACT

A display device includes pixel circuits and a scanning line driving circuit that supplies control signals to the pixel circuits through scanning lines. The scanning line driving circuit generates a control signal that transitions between a reference potential and a control potential, with the control potential being altered dependent upon a temperature condition.

### BACKGROUND

The present disclosure relates to a display device, a method of driving a display device, and an electronic apparatus.

A drive system of an organic EL display device is roughly divided into a passive matrix system and an active matrix system. In the passive matrix system, a pixel circuit that includes an organic EL element is connected to an intersection portion of each of scanning lines that are line-sequentially scanned and a signal line, and a drive current of the organic EL element flows through the selected scanning line and the selected signal line. In such a passive matrix system, since the configuration of a complicated device is not necessary, the manufacturing process of the device is simpler than the active matrix system.

In the active matrix system, as described in, for example, Japanese Unexamined Patent Application Publication No. 2006-215274, a pixel circuit that is provided with an organic EL element, a sampling transistor, a transistor for driving, a storage capacitor, and the like is disposed at an intersection portion of a scanning line and a signal line. At the intersection portion of the scanning line that is line-sequentially scanned and the signal line, a signal potential of the signal line is retained in the storage capacitor, and a drive current of the organic EL element has a size according to the signal potential that the storage capacitor retains. In the active matrix system, since the drive current is supplied at the time of a non-selection of the scanning line, compared to the passive matrix system, a frame period is long and an increase in the size of a display device is possible.

### SUMMARY

According to one embodiment described herein, a display device includes pixel circuits and a scanning line driving circuit that supplies control signals to the pixel circuits through scanning lines. The scanning line driving circuit generates a control signal that transitions between a reference potential and a control potential, with the control potential being altered dependent upon a temperature condition.

According to another embodiment, there is provided a display device including: a plurality of pixel circuits; and a scanning line driving circuit that supplies control signals to the plurality of pixel circuits through scanning lines, wherein the scanning line driving circuit includes a voltage supply circuit that supplies a control potential, and an output buffer that generates the control signal by switching between a reference potential and the control potential, and the voltage supply circuit increases a difference between the control potential and the reference potential as operating temperature increases.

According to another embodiment, there is provided a method of driving a display device that includes a plurality of pixel circuits, and a scanning line driving circuit that supplies control signals to the plurality of pixel circuits through scanning lines, wherein the scanning line driving circuit includes a voltage supply circuit that supplies a control potential, and an output buffer that generates the control signal by switching between a reference potential and the control potential, the method including: increasing a difference between the control potential and the reference potential as operating temperature increases, when generating the control signal by switching between the reference potential and the control potential.

According to at least one of the embodiments described herein, since a difference between the control potential and the reference potential is increased as operating temperature increases, blunting of the control signal by a rise in operating temperature is suppressed. Therefore, a change in a transient response period of the control signal that is input to the pixel circuit according to the operating temperature of the display device is suppressed.

### BRIEF DESCRIPTION OF THE DRAWINGS

FIG. 1 is a block diagram illustrating the overall configuration of a display device according to an embodiment of the present disclosure.

FIG. 2 is a circuit diagram illustrating the configuration of a pixel circuit in the embodiment.

FIG. 3 is a timing chart illustrating a mode of driving the display device according to the embodiment.

FIG. 4 is a diagram illustrating a display area of a pixel array in the embodiment.

FIG. 5 is a waveform diagram of a control signal that is used in a mobility correction operation in the embodiment.

FIG. 6 is a block diagram illustrating the configuration of a light scanner in the embodiment.

FIG. 7 is a circuit diagram illustrating the configuration of an output buffer in the embodiment.

FIG. 8 is a waveform diagram illustrating temperature dependence of the waveform of a gate pulse in an example of the related art.

FIG. 9 is a waveform diagram illustrating temperature dependence of the waveform of a gate pulse in the embodiment.

FIG. 10 is a waveform diagram illustrating the gate pulse at the same temperature.

FIG. 11 is a graph illustrating the relationship between a crosstalk rate and temperature in the embodiment.

FIG. 12 is a perspective view of an e-book reader that is an example of an electronic apparatus according to an embodiment of the present disclosure.

FIG. 13 is a perspective view of a personal computer that is an example of the electronic apparatus according to an embodiment of the present disclosure.

FIG. 14 is a perspective view of a television that is an example of the electronic apparatus according to an embodiment of the present disclosure.

FIG. 15 is a perspective view of a digital still camera that is an example of the electronic apparatus according to an embodiment of the present disclosure.

FIG. 16 is a plan view of the digital still camera that is an example of the electronic apparatus according to an embodiment of the present disclosure.

FIG. 17 is a perspective view of a digital video camera that is an example of the electronic apparatus according to an embodiment of the present disclosure.

FIG. 18 is a perspective view of a mobile phone terminal that is an example of the electronic apparatus according to an embodiment of the present disclosure.

FIG. 19 is a perspective view of the mobile phone terminal that is an example of the electronic apparatus according to an embodiment of the present disclosure.

### DETAILED DESCRIPTION OF EMBODIMENTS

In systems such as those introduced in the background above, each of a plurality of scanning lines is connected to a light scanner that outputs a pulse signal, and the light scanner supplies a control signal for controlling the luminescence of the organic EL element to each of the plurality of scanning lines in a form of a pulse signal. Usually, in an output circuit of the light scanner, since the waveform of the control signal is shaped through an output buffer such as an inverter circuit, the waveform of the control signal is deformed in response to a change in the operating temperature of the display device. As a result, variation in a transient response period in the control signal occurs, and thus the luminescence state of the organic EL element changes.

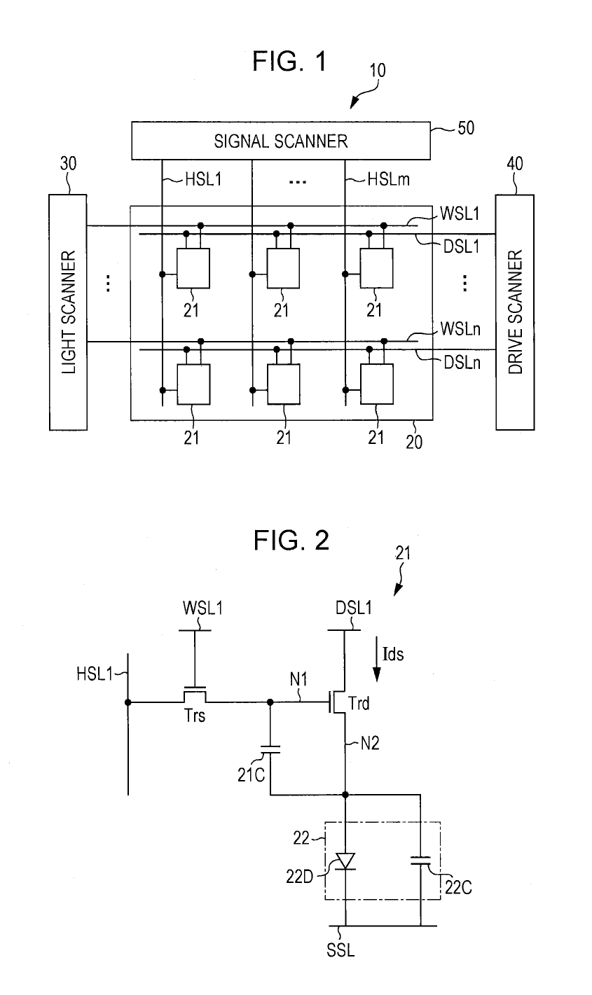

It is desirable to provide a display device in which it is possible to suppress a change in the transient response period of a control signal that is input to a pixel circuit according to the operating temperature of the display device, a method of driving the display device, and an electronic apparatus. Hereinafter, an embodiment in which a display device according to an embodiment of the present disclosure is embodied in an organic EL display device will be described. First, the configuration of an overall circuit that is included in the organic EL display device will be described with reference to FIG. 1.

As illustrated in FIG. 1, a display device 10 includes a pixel array 20, a light scanner 30 as a scanning line driving circuit, a drive scanner 40, and a signal scanner 50 as a signal line driving circuit. The pixel array 20 may be formed on the same substrate as at least one of the light scanner 30, the drive scanner 40, and the signal scanner 50 and may also be formed on a different substrate from the light scanner 30, the drive scanner 40, and the signal scanner 50.

The pixel array 20 includes a plurality of scanning lines WSL1 to WSLn extending in a row direction, a plurality of power supply lines DSL1 to DSLn respectively provided parallel to the plurality of scanning lines WSL1 to WSLn, and signal lines HSL1 to HSLm extending in a column direction. The pixel array 20 has a pixel circuit 21 provided at each of sites where the plurality of scanning lines WSL1 to WSLn and the plurality of signal lines HSL1 to HSLm intersect each other.

The light scanner 30 outputs a gate pulse to each of the plurality of scanning lines WSL1 to WSLn in order from the scanning line WSL1 to the scanning line WSLn. The light scanner 30 switches a potential that is applied to the pixel circuit 21, between a write potential VDDWS that is a control potential higher than a reference potential VSSWS and the reference potential VSSWS according to the output of the gate pulse that is a control signal.

The drive scanner 40 switches a potential to each of the plurality of power supply lines DSL1 to DSLn in order from the power supply line DSL1 to the power supply line DSLn, in accordance with the output of the gate pulse of the light scanner 30. The drive scanner 40 switches a potential that is applied to the pixel circuit 21, between a drive potential Vccp that is a high potential and an initialization potential Vini that is a low potential.

The signal scanner 50 generates signal potentials for all the pixel circuits 21 as display signals in order on a line-by-line basis by using a video signal from the outside. The signal scanner 50 switches the potential of each of the plurality of signal lines HSL1 to HSLm from an offset potential Vofs to a signal potential Vsig all at once in accordance with the output of the gate pulse of the light scanner 30.

Next, the configuration of the pixel circuit 21 will be described with reference to FIG. 2. In addition, in each of the plurality of pixel circuits 21, while the scanning line, the power supply line, and the signal line, which are connected to the pixel circuit 21, are different from each other, other configurations are the same. Therefore, in the following, the pixel circuit 21 which is connected to the scanning line WSL1, the power supply line DSL1, and the signal line HSL1 is mainly described and description of the other pixel circuits 21 is omitted.

As illustrated in FIG. 2, the pixel circuit 21 includes an organic EL element 22, a sampling transistor Trs, a transistor for driving Trd, and a storage capacitor 21C.

A gate that is a control end of the sampling transistor Trs is connected to the scanning line WSL1, a source that is a current end of the sampling transistor Trs is connected to the signal line HSL1, and a drain that is a current end of the sampling transistor Trs is connected to a gate N1 that is a control end of the transistor for driving Trd.

A source N2 that is a current end of the transistor for driving Trd is connected to an anode of the organic EL element 22, and a drain that is a current end of the transistor for driving Trd is connected to the power supply line DSL1. The storage capacitor 21C is connected between the gate N1 and the source N2 of the transistor for driving Trd.

A cathode of the organic EL element 22 is connected to a grounding wiring SSL. In addition, the grounding wiring SSL is common to all the pixel circuits 21.

The sampling transistor Trs enters a conduction state according to the write potential VDDWS that is applied to the scanning line WSL1. In a state where the sampling transistor Trs enters the conduction state and the offset potential Vofs is applied to the signal line HSL1, the potential of the power supply line DSL1 is switched from the initialization potential Vini that is a low potential to the drive potential Vccp that is a high potential. By such switching of the potential of the power supply line DSL1, a voltage equivalent to a threshold voltage Vth of the transistor for driving Trd is retained in the storage capacitor 21C.

In a state where the voltage equivalent to the threshold voltage Vth is retained in the storage capacitor 21C, the sampling transistor Trs enters a conduction state and the potential of the signal line HSL1 is switched from the offset potential Vofs to the signal potential Vsig. By such switching of the potential of the signal line HSL1, the signal potential Vsig is sampled and retained in the storage capacitor 21C.

The transistor for driving Trd receives current supply from the power supply line DSL1 which is at the drive potential Vccp, in a non-conduction state of the sampling transistor Trs, thereby making a drain current Ids according to a potential which is retained in the storage capacitor 21C flow to the organic EL element 22.

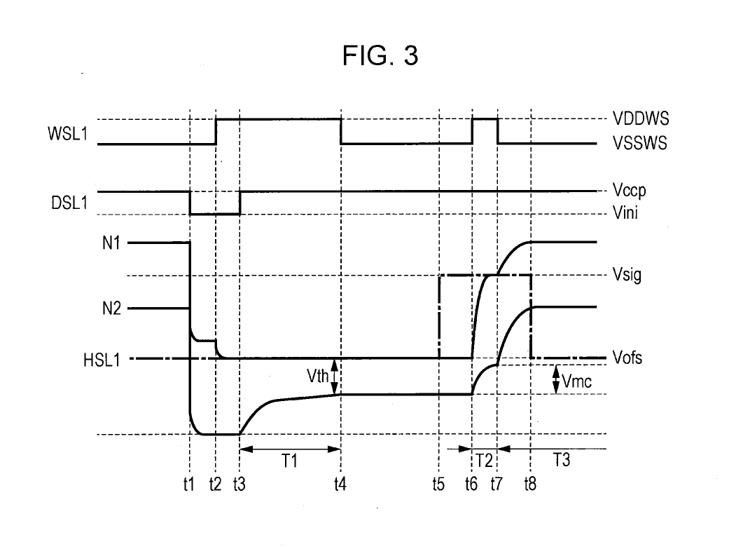

Next, an operation of the display device 10 will be described with reference to FIG. 3 with a focus on a write operation in the pixel circuit 21. In addition, in each of the plurality of pixel circuits 21, in the scanning line, the power supply line, and the signal line which are connected to the pixel circuit 21, an application procedure of the potential is the same. Therefore, the pixel circuit 21 which is connected to the scanning line WSL1, the power supply line DSL1, and the signal line HSL1 is mainly described and description of the other pixel circuits 21 is omitted.

In FIG. 3, a change in the potential of the scanning line WSL1, a change in the potential of the power supply line DSL1, a change in the potential of the signal line HSL1, a change in the potential of the gate N1 of the transistor for driving Trd, and a change in the potential of the source N2 of the transistor for driving Trd are shown in a common time axis.

First, at timing t1, preparation for a threshold value correction operation is started.

At the timing t1, in a state where the reference potential VSSWS is applied to the scanning line WSL1, the potential of the power supply line DSL1 is switched from the drive potential Vccp to the initialization potential Vini. Accordingly, the potential of the source N2 of the transistor for driving Trd is initialized to the initialization potential Vini. In addition, the initialization potential Vini is a potential that is sufficiently lower than the offset potential Vofs that is applied to the signal line HSL1. Specifically, the initialization potential Vini is set such that the potential between the gate N1 and the source N2 of the transistor for driving Trd becomes larger than the threshold voltage Vth of the transistor for driving Trd.

At timing t2, the potential of the scanning line WSL1 is switched from the reference potential VSSWS to the write potential VDDWS. Accordingly, the potential of the gate N1 of the transistor for driving Trd is initialized to the offset potential Vofs. The potential of the gate N1 of the transistor for driving Trd and the potential of the source N2 of the transistor for driving Trd are initialized, whereby preparation for a threshold voltage correction operation is completed.

Subsequently, at timing t3, the threshold value correction operation is started.

At the timing t3, the potential of the power supply line DSL1 is switched from the initialization potential Vini to the drive potential Vccp. Accordingly, the potential of the source N2 of the transistor for driving Trd begins to transition such that the potential between the gate N1 and the source N2 of the transistor for driving Trd becomes the threshold voltage Vth. In a period from the timing t3 to timing t4, a voltage equivalent to the threshold voltage Vth is written to the storage capacitor 21C connected between the gate N1 and the source N2 of the transistor for driving Trd. Then, at the time t4 when the voltage between the gate N1 and the source N2 of the transistor for driving Trd becomes the threshold voltage Vth, the potential of the scanning line WSL1 is switched from the write potential VDDWS to the reference potential VSSWS. In addition, the potential of the grounding wiring SSL is set such that the drain current Ids during this time flows to the storage capacitor 21C and does not flow to the organic EL element 22, that is, such that an operating area of the organic EL element 22 is in a cut-off state. Accordingly, in a threshold voltage correction period T1 from the timing t3 to the timing t4, a voltage equivalent to the threshold voltage Vth is retained between the gate N1 and the source N2 of the transistor for driving Trd, and thus the threshold value correction operation is completed.

Subsequently, at timing t5, a mobility correction operation is started.

At the timing t5, the potential of the signal line HSL1 is switched from the offset potential Vofs to the signal potential Vsig. At timing t6, the potential of the scanning line WSL1 is switched from the reference potential VSSWS to the write potential VDDWS, and thus the sampling transistor Trs enters a conduction state. Accordingly, the potential of the gate N1 of the transistor for driving Trd becomes the signal potential Vsig and also the voltage between the gate N1 and the source N2 of the transistor for driving Trd becomes a voltage in which the threshold voltage Vth is added to a difference between the signal potential Vsig and the offset potential. That is, the storage capacitor 21C retains a voltage in which the threshold voltage Vth is added to a difference between the signal potential Vsig and the offset potential.

At this time, since the transistor for driving Trd enters a conduction state, while the operating area of the organic EL element 22 is still in a cut-off state, the drain current of the transistor for driving Trd flows to a parasitic capacitance 22C of the organic EL element 22, and thus the parasitic capacitance 22C begins to be charged. Accordingly, the potential of the anode of the organic EL element 22, that is, the source N2 of the transistor for driving Trd begins to rise. The voltage between the gate N1 and the source N2 of the transistor for driving Trd is reduced by a mobility correction voltage Vmc that corresponds to the amount of rise in the potential of the source N2 of the transistor for driving Trd. As a result, since the larger the mobility of the transistor for driving Trd is, the larger the absolute value of the mobility correction voltage Vmc (that is a negative feedback) becomes, in the voltage between the gate N1 and the source N2 of the transistor for driving Trd, variation in the mobility of each transistor for driving Trd is eliminated. Further, since the larger a difference between the signal potential Vsig and the offset potential Vofs is, the larger the drain current of the transistor for driving Trd becomes and since the absolute value of the mobility correction voltage Vmc also becomes large, the absolute value of the mobility correction voltage Vmc becomes a size according to an emission luminance. Accordingly, the mobility correction operation is completed in a mobility correction period T2 from the timing t6 to timing t7.

Subsequently, at the timing t7, a luminescence operation is started.

At the timing t7, the potential of the scanning line is switched from the write potential VDDWS to the reference potential VSSWS, and thus the gate N1 of the transistor for driving Trd is separated from the signal line HSL1. According to this, the drain current Ids of the transistor for driving Trd begins to flow to the organic EL element 22. The potential of the anode of the organic EL element 22, that is, the potential of the source N2 of the transistor for driving Trd rises according to the drain current Ids. If the potential of the source N2 of the transistor for driving Trd rises, the potential of the gate N1 of the transistor for driving Trd also rises due to a bootstrap operation of the storage capacitor 21C.

At this time, the amount of rise in the potential of the gate N1 of the transistor for driving Trd is equal to the amount of rise in the potential of the source N2 of the transistor for driving Trd. Therefore, in a luminescence period T3 that is started from the timing t7, the voltage between the gate N1 and the source N2 of the transistor for driving Trd is maintained constant from the time of start of a luminescence operation. Thus, the organic EL element 22 emits light at a luminance according to a voltage that the storage capacitor 21C retains. Then, a drive current that drives the organic EL element 22 is generated in a state where variation in the threshold voltage Vth and variation in mobility are corrected. For this reason, the luminance of the organic EL element 22 is not affected by variation in the threshold voltage Vth or the mobility of the transistor for driving Trd.

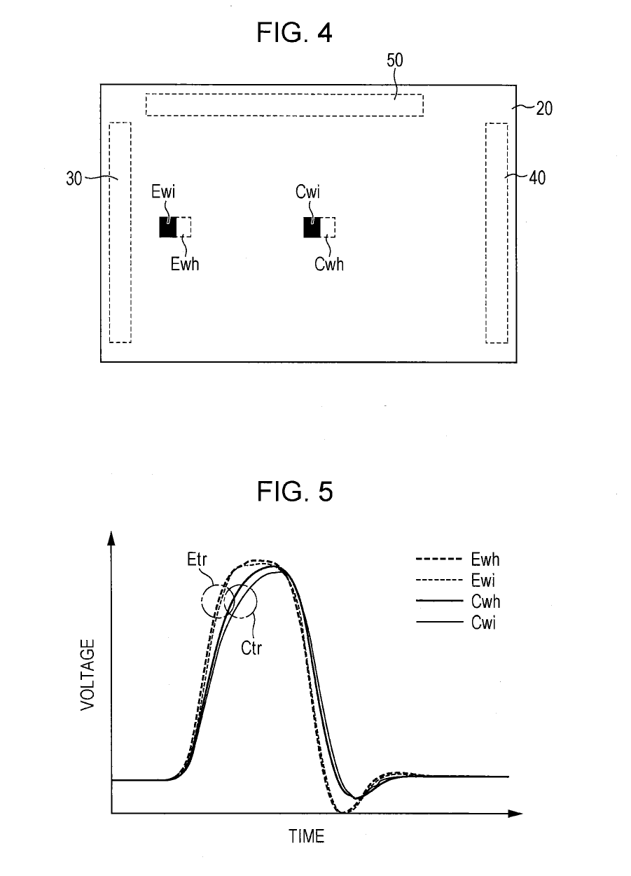

Next, the waveform of the gate pulse that it output from the light scanner 30 to each of the scanning lines WSL1 to WSLn will be described. First, the waveform of a gate pulse in the mobility correction period T2 that a light scanner in the related art outputs will be described with reference to FIGS. 4 and 5.

In addition, FIG. 4 is a diagram illustrating a pixel area that is used in the description of the waveform of the gate pulse. In FIG. 4, an area that is displayed in white on the display device 10 is shown with white, and an area that is displayed in black on the display device 10 is shown with black.

As illustrated in FIG. 4, at a left end portion of the pixel array 20, a window area where the organic EL element 22 does not emit light is set as a partition end portion Ewi. Similarly, at the left end portion of the pixel array 20, an area that is displayed in white is set as a white end portion Ewh. The partition end portion Ewi and the white end portion Ewh are adjacent to each other. Further, at a central portion of the pixel array 20, a window area where the organic EL element 22 does not emit light is set as a partition central portion Cwi. At the central portion of the pixel array 20, an area that is displayed in white is set as a white central portion Cwh. The partition central portion Cwi and the white central portion Cwh are adjacent to each other.

As illustrated in FIG. 5, in a waveform Ctr (an area surrounded by a dashed-dotted line) of a gate pulse at the central portion of the pixel array 20, a voltage rising period is longer and the waveform becomes duller than in a waveform Etr (an area surrounded by a dashed-dotted line) of a gate pulse at the left end portion of the pixel array 20. Specifically, in the waveform of the gate pulse at the white central portion Cwh, compared to the waveform of the gate pulse at the white end portion Ewh, the voltage rising period is long and the waveform becomes dull. Similarly, in the waveform of the gate pulse at the partition central portion Cwi, compared to the waveform of the gate pulse at the partition end portion Ewi, the voltage rising period is long and the waveform becomes dull.

Further, in the waveform of the gate pulse in the window area, the voltage rising period is longer and the waveform becomes duller than in the waveform of the gate pulse at the white area. Specifically, in the waveform of the gate pulse at the partition central portion Cwi, compared to the waveform of the gate pulse at the white central portion Cwh, the voltage rising period is long and the waveform becomes dull. Similarly, in the waveform of the gate pulse at the partition end portion Ewi, compared to the waveform of the gate pulse at the white end portion Ewh, the voltage rising period is long and the waveform becomes dull.

Such a difference in a transient response period is caused, for example, by the fact that the lengths of transmission paths of the gate pulses are different from each other. Further, such a difference in the transient response period is caused, for example, by the fact that the load capacity between the gate and the source of the sampling transistor Trs is different between the time of luminescence of the organic EL element 22 and the time of non-luminescence of the organic EL element 22.

Here, when the transient response period is too short, a difference in the transient response period becomes large between the pixel circuit 21 close to the light scanner and the pixel circuit 21 that is distant from to the light scanner. As a result, in the pixel circuits 21 adjacent to each other in an extending direction of the scanning line, crosstalk is generated that is a phenomenon in which the respective images are mixed with each other.

For example, when a voltage rising period in the gate pulse is too short, the degree of dullness of the gate pulse at the white central portion Cwh becomes larger than in other areas. At this time, if the parasitic capacitance 22C in the organic EL element 22 is set as a capacitance value C0, the mobility correction voltage Vmc described above is determined by an expression, Vmc=Ids×C0/T2. Then, since at the white central portion Cwh, the mobility correction period T2 becomes longer than in other areas, the absolute value of the mobility correction voltage Vmc becomes larger than necessary. As a result, an image at the white central portion Cwh is darkly displayed, and thus an image at the partition central portion Cwi and the image at the white central portion Cwh are mixed with each other.

On the other hand, when the transient response period is too long, writing to the pixel circuit 21 is insufficient in a scanning line selection period and as a result, the organic EL element 22 does not emit light at a luminance according to the signal potential Vsig.

For example, when a voltage rising period in the gate pulse is too long, writing of the signal potential Vsig to the storage capacitor 21C is not completed in the mobility correction period T2 described above. As a result, an image at the white central portion Cwh is darkly displayed, or a voltage that is written to the storage capacitor 21C in the mobility correction period T2, that is, the luminance of the organic EL element 22 becomes different from the extent that is originally desired.

In this manner, an optimum transient response period is necessary for the gate pulse that the light scanner outputs. On the other hand, in an output circuit of the light scanner, usually, the waveform of the gate pulse is shaped through an output buffer such as an inverter circuit. However, as the operating temperature of the display device 10 increases, the waveform of such a gate pulse tends to become dull. As a result, for example, even if the transient response period is optimum when the operating temperature of the display device 10 is a low temperature, when the operating temperature of the display device 10 is a high temperature, the transient response period eventually becomes too long. Alternatively, even if the transient response period is optimum when the operating temperature of the display device 10 is a high temperature, when the operating temperature of the display device 10 is a low temperature, the transient response period eventually becomes too short. Therefore, in order to suppress a change in the transient response period by the operating temperature of the display device 10, in the light scanner 30 described above, a voltage supply circuit of the output buffer has a temperature correction function.

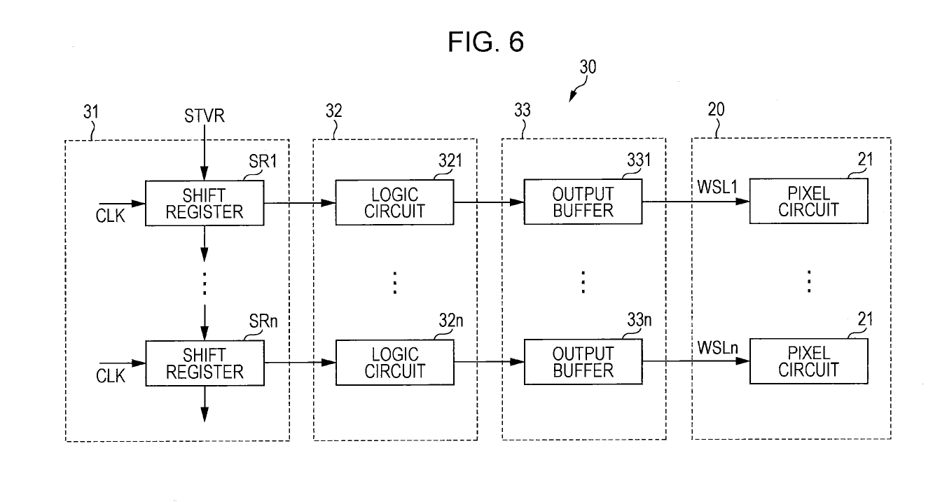

Next, the overall configuration of the light scanner 30 having the temperature correction function will be described with reference to FIG. 6.

As illustrated in FIG. 6, the light scanner 30 includes a shift register 31, a logic circuit 32, and an output buffer 33. The shift register 31 starts a shift operation using a clock CLK according to an input of a shift start pulse STVR. The shift start pulse STVR is input once in a single field period.

The logic circuit 32 generates the waveform of the gate pulse by using an output pulse of the shift register 31. For example, a first stage logic circuit 321 generates the waveform of the gate pulse by using an output pulse of a first stage shift register SR1, and an n-th stage logic circuit 32n generates the waveform of the gate pulse by using an output pulse of an n-th stage shift register SRn.

The output buffer 33 converts the gate pulse generated by the logic circuit 32 to an operation control level in the pixel circuit 21 to thereby shape a waveform. For example, a first stage output buffer 331 converts the gate pulse generated by the first stage logic circuit 321 to an operation control level in the pixel circuit 21 and outputs a gate pulse after waveform shaping to the scanning line WSL1. An n-th stage output buffer 33n converts the gate pulse generated by the n-th stage logic circuit 32n to an operation control level in the pixel circuit 21 and outputs a gate pulse after waveform shaping to the scanning line WSLn.

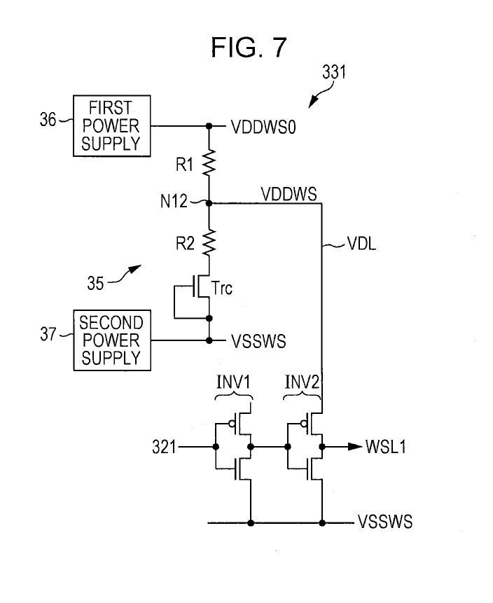

Next, the configuration of the output buffer 33 will be described with reference to FIG. 7. In addition, in each of the plurality of output buffers 33l to 33n, while the logic circuit 32 and the scanning line which are connected to the output buffer are different from each other, other configurations are the same. Therefore, in the following, the configuration of the output buffer 331 which is connected to the first stage logic circuit 32l and the scanning line WSL1 is mainly described and the description of the other output buffers is omitted.

As illustrated in FIG. 7, the output buffer 331 includes a first inverter circuit INV1 which is connected to an output terminal of the logic circuit 321, and a second inverter circuit INV2.

The first inverter circuit INV1 has an output terminal provided by connecting the drains of a PMOS transistor and an NMOS transistor. The source of the PMOS transistor in the first inverter circuit INV1 is connected to a power supply potential VDDWS0. The source of the NMOS transistor in the first inverter circuit INV1 is connected to the reference potential VSSWS. The first inverter circuit INV1 may also be a simple gate circuit constituted by only a PMOS transistor or an NMOS transistor. The second inverter circuit INV2 is connected to the output terminal of the first inverter circuit INV1.

The second inverter circuit INV2 is a final stage inverter circuit in the output buffer 331 and has an output terminal provided by connecting the drains of a PMOS transistor and an NMOS transistor. The output terminal of the second inverter circuit INV2 is connected to the scanning line WSL1. The source of the PMOS transistor in the second inverter circuit INV2 is connected to a voltage supply circuit 35 through a control potential line VDL. The source of the NMOS transistor in the second inverter circuit INV2 is connected to the reference potential VSSWS. The second inverter circuit INV2 may also be a simple gate circuit constituted by only a PMOS transistor or an NMOS transistor. In addition, the output buffer 331 may also have a configuration in which the first inverter circuit INV1 is omitted and the output terminal of the logic circuit 321 is connected to an input terminal of the second inverter circuit INV2, and may also be configured so as to have three or more stage inverter circuits. In short, the output buffer 331 may have a configuration in which the final stage inverter circuit is connected to the voltage supply circuit 35.

The voltage supply circuit 35 includes a resistor element R1 and a transistor for temperature correction Trc which is connected in series to the resistor element R1 and includes a parasitic resistance R2. The resistor element R1 is connected to a first power supply 36, and the first power supply 36 supplies the power supply potential VDDWS0 that is a first potential higher than the write potential VDDWS. The voltage supply circuit 35 and the output buffer 331 respectively include transistors which are formed on the same substrate and have semiconductor layers laminated on a common foundation layer.

A connection node N12 between the resistor element R1 and the transistor for temperature correction Trc is connected to the source of the PMOS transistor in the second inverter circuit INV2 through the control potential line VDL. The transistor for temperature correction Trc is a diode-connected NMOS transistor, the drain thereof is connected to the resistor element R1, and the source and the drain are connected to a second power supply 37. The second power supply 37 supplies the reference potential VSSWS that is a second potential lower than the write potential VDDWS to the transistor for temperature correction Trc.

In the voltage supply circuit 35, the transistor for temperature correction Trc and the resistor element R1 electrically connected in series to the transistor for temperature correction Trc constitute a resistance division circuit. The resistance division circuit includes a series circuit of the ON resistance of the transistor for temperature correction Trc and the parasitic resistance R2, and the potential of the connection node N12 between the resistor element R1 and the transistor for temperature correction Trc performs resistance division of a potential difference between the power supply potential VDDWS0 and the reference potential VSSWS. That is, the potential of the connection node N12 is determined by the resistance division ratio between a combined resistance value of the ON resistance in the transistor for temperature correction Trc and the parasitic resistance R2, and the resistance value of the resistor element R1.

If the operating temperature of the display device 10 rises, the ON resistance of the transistor for temperature correction Trc rises, and thus a voltage drop in the transistor for temperature correction Trc becomes large. As a result, the potential of the connection node N12 between the resistor element R1 and the transistor for temperature correction Trc rises, and thus the write potential VDDWS which is supplied to the second inverter circuit INV2 also rises. As described above, as the operating temperature of the display device 10 increases, the waveform of the gate pulse tends to become dull. However, blunting of the waveform of the gate pulse is suppressed by a rise in the write potential VDDWS.

For example, the resistance value of the resistor element R1 is set as Ry (Ω), and the combined resistance value of the ON resistance of the transistor for temperature correction Trc and the parasitic resistance R2 is set as Rx (Ω). Further, the combined resistance value when the operating temperature of the display device 10 is 25° C. is set as Rx (Ω), and the combined resistance value when the operating temperature of the display device 10 is 75° C. is set as 1.2×Rx (Ω). In addition, the ON resistance of the transistor for temperature correction Trc is approximately equal to the parasitic resistance R2.

In this case, the write potential VDDWS when the operating temperature of the display device 10 is 25° C. is expressed by the following Expression (1), and the write potential VDDWS when the operating temperature of the display device 10 is 75° C. is expressed by the following Expression (2).

VDDWS=Rx/(Rx+Ry)×VDDWS0 (1)

VDDWS=1.2×Rx/(1.2×Rx+Ry)×VDDWS0 (2)

In a case where the power supply potential VDDWS0 is set to be 12 (V), Rx is set to 1 (Ω), Ry is set to 0.005 (Ω), and the operating temperature is 25° C., 11.43 (V) is generated as the write potential VDDWS on the basis of the above Expression (1).

In a case where the power supply potential VDDWS0 is set to be 12 (V), Rx is set to 1 (Ω), Ry is set to 0.005 (Ω), and the operating temperature is 75° C., 11.52 (V) is generated as the write potential VDDWS on the basis of the above Expression (2).

In this manner, in a case where the operating temperature of the display device 10 rises from 25° C. to 75° C., the output voltage of the voltage supply circuit 35 actively changes, and thus the write potential VDDWS rises by about 0.1 (V), compared to a case where the operating temperature is 25° C. In a case where the operating temperature of the display device 10 rises from 25° C. to 75° C., usually, the waveform of the gate pulse tends to become dull. However, the write potential VDDWS rises by about 0.1 (V), whereby blunting of the waveform of the gate pulse is suppressed.

### EXAMPLE

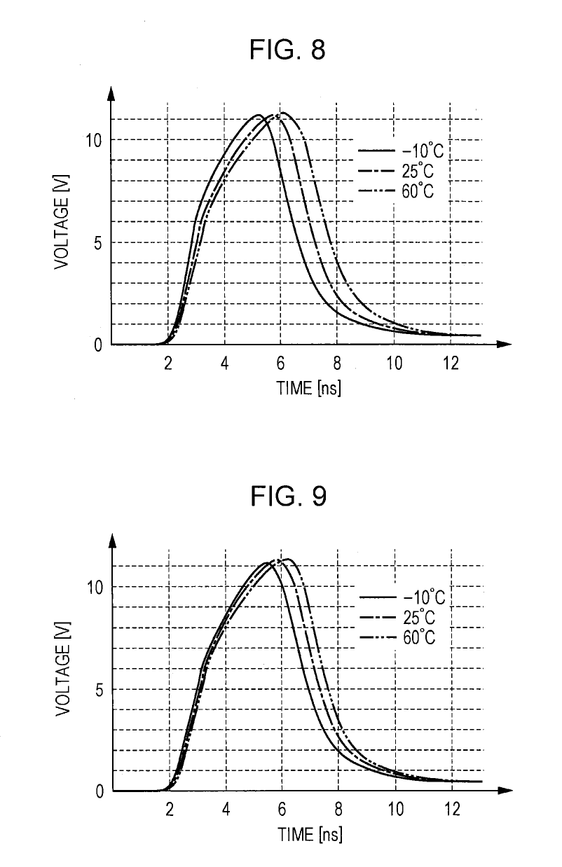

Next, the temperature dependence of the gate pulse that is output by the light scanner 30 will be described along with a temperature dependence of a gate pulse in an example of the related art with reference to FIGS. 8 to 11. In addition, a configuration in which the source of the PMOS transistor of the second inverter circuit INV2 is directly connected to the power supply potential VDDWS0 is equivalent to a light scanner in the example of the related art, and the gate pulse in the example of the related art is obtained by such a light scanner.

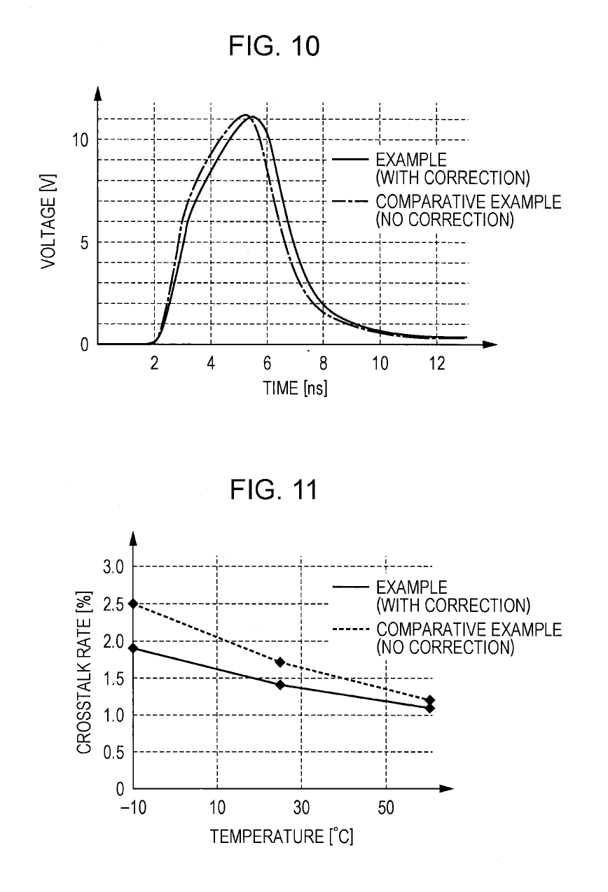

FIG. 8 is a waveform diagram illustrating the gate pulse at each temperature in the example of the related art, and FIG. 9 is a waveform diagram illustrating the gate pulse at each temperature that is output by the light scanner 30, as an example. FIG. 10 is a waveform diagram illustrating the gate pulse in the example of the related art when the operating temperature of the display device is −10° C., and the gate pulse in the example when the operating temperature likewise is −10° C. FIG. 11 illustrates a crosstalk rate in the central portion of the pixel array 20 with respect to each of the example and the example of the related art. In addition, Rx and Ry in the resistance division circuit described above are set such that when the operating temperature of the display device 10 is 60° C., the waveform of the gate pulse in the example and the waveform of the gate pulse in the example of the related art approach each other.

As illustrated in FIG. 8, in the gate pulse in the example of the related art, as the operating temperature of the display device rises from −10° C. to 60° C., a voltage rising period becomes long. At this time, while a peak voltage that is the amplitude of the gate pulse is generally maintained in the range of measurement temperature, a pulse width gradually becomes long as the operating temperature rises.

As illustrated in FIG. 9, in the gate pulse in the example, as the operating temperature of the display device rises from −10° C. to 60° C., a voltage rising period becomes slightly long. However, any increase of an increase in the voltage rising period that is recognized when the operating temperature is changed from −10° C. to 25° C. and an increase in the voltage rising period that is recognized when the operating temperature is changed from 25° C. to 60° C. is sufficiently suppressed compared to the example of the related art.

In the gate pulse in the example, similarly to the gate pulse in the example of the related art, a pulse width becomes slightly long as the operating temperature rises. However, any increase of an increase in pulse width that is recognized when the operating temperature is changed from −10° C. to 25° C. and an increase in the pulse width that is recognized when the operating temperature is changed from 25° C. to 60° C. is sufficiently suppressed compared to the example of the related art. In addition, as the operating temperature of the display device rises from −10° C. to 60° C., a peak voltage that is the amplitude of the gate pulse in the example is gradually increased by the correction of the above-described write potential VDDWS.

As illustrated in FIG. 10, in a case where the operating temperature of the display device 10 is −10° C., in the gate pulse in the example, compared to the gate pulse in the example of the related art, the voltage rising period is long. On the other hand, as described above, the gate pulse in the example is set such that when the operating temperature of the display device 10 is 60° C., the waveform of the gate pulse approaches the waveform of the gate pulse in the example of the related art. Therefore, in the gate pulse in the example, the gate pulse is corrected such that the waveform of the gate pulse at a low temperature in the example of the related art approaches the waveform of the gate pulse at a high temperature.

As illustrated in FIG. 11, a crosstalk rate in the example is lower than a crosstalk rate in a comparative example in an entire measuring range from −10° C. to 60° C. Such suppression of the crosstalk rate is prominently recognized in a low-temperature operating range. This is because the correction of the gate pulse in the example is carried out as described above. That is, this is because the gate pulse in the example is corrected such that the waveform of the gate pulse at the low temperature in the example of the related art approaches the waveform of the gate pulse at a high temperature.

In addition, as the operating temperature lowers, both the crosstalk rate in the example and the crosstalk rate in the comparative example increase. This is because a difference in transient response period becomes large between the pixel circuit 21 close to the light scanner and the pixel circuit 21 that is distant from to the light scanner because the transient response period is short at the low operating temperature. According to the correction of the gate pulse by the light scanner 30 described above, it is also possible to reduce temperature dependence of such a crosstalk rate.

As described above, according to the embodiment described above, the following effects can be obtained.

Since a difference between the write potential VDDWS and the reference potential VSSWS becomes large as the operating temperature of the display device 10 rises, blunting of the gate pulse by a rise in the operating temperature is suppressed. Therefore, a change in the transient response period of the write potential VDDWS that is input to the pixel circuit 21, by a rise in the operating temperature, is suppressed.

Since a difference between the write potential VDDWS and the reference potential VSSWS becomes small as the operating temperature of the display device 10 lowers, steepening of the gate pulse by a decrease in operating temperature is suppressed. Therefore, a change in the transient response period of the write potential VDDWS that is input to the pixel circuit 21, by a decrease in the operating temperature, is suppressed.

The correction of the write potential VDDWS is realized by the diode-connected transistor for temperature correction Trc. Here, in the pixel array 20 in which the plurality of pixel circuits 21 are arranged, usually, the sampling transistor Trs or the transistor for driving Trd is formed in the same process. Then, in a process in which the sampling transistor Trs or the transistor for driving Trd is formed, it is also possible to form the transistor for temperature correction Trc together. Therefore, compared to a case where elements other than a transistor are used for temperature corrections, a load on the manufacture of the display device 10 is reduced.

The ON resistance of the transistor for temperature correction Trc is set to be larger than the resistance value of the resistor element R1. For example, as described in the example, Rx is set to 1 (Ω) and Ry is set to 0.005 (Ω). The ON resistance of a MOS transistor usually becomes small as a design rule of a transistor. In this regard, if it is a configuration in which the ON resistance of the transistor for temperature correction Trc is larger than in the resistor element R1, a reduction in a design rule of the transistor for temperature correction Trc is suppressed, and thus the desire for miniaturization of the transistor for temperature correction Trc is also suppressed. As a result, it also becomes possible to form the transistor for temperature correction Trc in the same process as the sampling transistor Trs or the transistor for driving Trd.

The voltage supply circuit 35 is connected to only the second inverter circuit INV2 that is the final stage inverter circuit. Therefore, it is also possible to minimize the number of newly added elements, such as the transistor for temperature correction Trc or the resistor element R1.

The gate pulse described above determines the ending time of the threshold voltage correction period T1. Further, the gate pulse described above determines the start time of the mobility correction period T2 and the ending time of the mobility correction period T2. That is, the result of the correction of the write potential VDDWS is applied over two or more times in a single scanning period. Therefore, the effect of suppressing variations in the transient response period becomes more pronounced.

In other words, a target in which it is necessary to perform a current control multiple times in a single scanning period, leads to a serious problem because of a difference in the transient response period of the extent that it changes according to a change in the operating temperature. Therefore, for such a target, temperature correction of a potential by the voltage supply circuit 35 exhibits a more pronounced effect.

In addition, the above-described embodiment can also be modified and implemented as follows.

A circuit that supplies a drive current to the organic EL element 22 is not limited to a circuit using the sampling transistor Trs and the transistor for driving Trd and may also be a current mirror circuit. If it is such a configuration, even in a case where a transistor does not function as a constant current source, it becomes possible to correct variations in the characteristics of a transistor or the characteristics of an organic EL element.

Each of the sampling transistor Trs and the transistor for driving Trd is not limited to an N-channel transistor, and at least one of the sampling transistor Trs and the transistor for driving Trd may also be a P-channel transistor.

In addition to the light scanner 30, the drive scanner 40 may also be provided with the voltage supply circuit 35 and the signal scanner 50 may also be provided with the voltage supply circuit 35. In addition, the light scanner 30 may also be formed at both the left and right ends of the pixel array 20 and the drive scanner 40 may also be formed at both the left and right ends of the pixel array 20.

A drive system of the display device 10 is not limited to an active matrix system and may also be a sub-field system in which a single frame is divided into a plurality of sub-fields and the sub-field is turned on or off in response to a video signal.

The transistor for temperature correction Trc is not limited to an NMOS transistor, may also be a PMOS transistor, and may also have a configuration in which an NMOS transistor and a PMOS transistor are used in combination.

Further, an element in which a resistance value rises according to a rise in temperature, the so-called element having positive dependence with respect to temperature may also be a thermistor in which a resistance value rises with respect to a rise in temperature, in addition to the transistor for temperature correction Trc.

Further, the number of elements having positive dependence with respect to temperature is not limited to one and may also be two or more, and in the case of two or more elements, the elements may also be connected in series with respect to the resistor element R1 and may also be connected in parallel with respect to the resistor element R1.

In addition, the element constituting the voltage supply circuit is not limited to an element having positive dependence with respect to temperature and may be an element having negative dependence with respect to temperature. In short, the voltage supply circuit may also have a configuration that increases a difference between the control potential and the reference potential as the operating temperature increases.

The resistance division circuit may also perform resistance division of a potential difference between a potential that is higher than the reference potential VSSWS and lower than the power supply potential VDDWS0 and the power supply potential VDDWS0 and determine the potential of the connection node N12 by a resistance division ratio of such a potential difference. Alternatively, the resistance division circuit may also perform resistance division of a potential difference between a potential that is lower than the reference potential VSSWS and the power supply potential VDDWS0 and determine the potential of the connection node N12 by a resistance division ratio of such a potential difference. In short, the resistance division circuit may also perform resistance division of a potential difference between a first potential that is higher than the control potential and a second potential that is lower than the control potential and determine the potential of the connection node N12 by a resistance division ratio of such a potential difference.

The number of inverter circuits that are included in the output buffer 33 may also be one and may also be three or more. In short, it is only necessary to have a configuration in which the final stage inverter circuit complementarily outputs a write potential that is a control potential and the reference potential.

The control signal may also be switched between a potential lower than the reference potential VSSWS and the reference potential VSSWS.

At this time, for example, the source of the PMOS transistor in the first inverter circuit INV1 and the source of the PMOS transistor in the second inverter circuit INV2 are connected to the reference potential VSSWS. Further, the source of the NMOS transistor in the first inverter circuit INV1 is connected to the power supply potential VDDWS0. Further, the source of the NMOS transistor in the second inverter circuit INV2 is connected to the connection node N12 of the resistance division circuit. Then, in the resistance division circuit, the resistor element R1 is connected to the reference potential VSSWS and the source of the transistor for temperature correction Trc is connected to the second power supply 37 that supplies a second potential lower than the reference potential VSSWS.

In addition, in the above configuration, the resistor element R1 may also be connected to the first power supply 36 that supplies a first potential that is lower than the reference potential VSSWS and higher than the control potential and then, the source of the transistor for temperature correction Trc may also be connected to the second power supply 37 that supplies a second potential lower than the control potential.

The gate pulse described above may also have a configuration of determining only the ending time of the threshold voltage correction period T1. For example, the start time of the mobility correction period T2 or the ending time of the mobility correction period T2 may also be determined based on signals other than the gate pulse that is generated by the output buffer 33.

The gate pulse described above may also have a configuration of determining only the start time of the mobility correction period T2 or the ending time of the mobility correction period T2. For example, the ending time of the threshold voltage correction period T1 may also be determined based on signals other than the gate pulse that is generated by the output buffer 33.

A potential that is supplied by the voltage supply circuit 35 may also be used for purposes other than the writing of a signal potential to a storage capacitor and may also be used in, for example, a pulse signal for selecting one scanning line from a plurality of scanning lines. In short, a potential that is supplied by the voltage supply circuit may also have a configuration of being used in a control signal that is supplied to each of a plurality of scanning lines, and a control target of the control signal may also be any one other than a write operation.

The display device 10 is not limited to an organic EL display device and may also be a liquid crystal display device, an LED display device, or a plasma display device. In short, it is acceptable if the display device according to an embodiment of the present disclosure has a configuration in which a voltage supply circuit is provided in a scanner that inputs a control signal to a pixel.

Electronic Apparatuses

An electronic apparatus that is provided with the display device 10 described above will be described. In addition, the display device 10 can be applied to a variety of uses and is not particularly limited. For this reason, in the following, for example, a configuration in which the display device 10 is applied to an electronic apparatus having a display section will be described. However, the configuration is only an example and appropriate changes can be made.

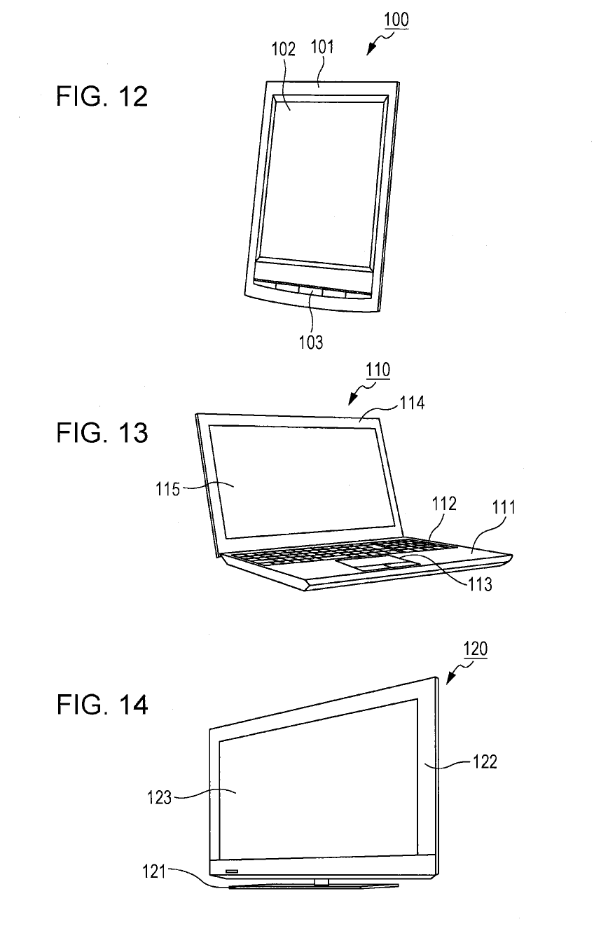

As illustrated in FIG. 12, in a casing 101 of an electronic book reader 100, a display section 102 that includes the display device 10 described above, and a manipulation button 103 for operating a display mode in the display section 102 are mounted.

As illustrated in FIG. 13, a keyboard 112 and an operating section 113 are mounted in a lower casing ill of a personal computer 110, and a display section 115 that includes the display device 10 described above is mounted in an upper casing 114 of the personal computer 110.

As illustrated in FIG. 14, a display section 123 that includes the display device 10 described above is mounted in a casing 122 mounted on a support base 121 of a television set 120.

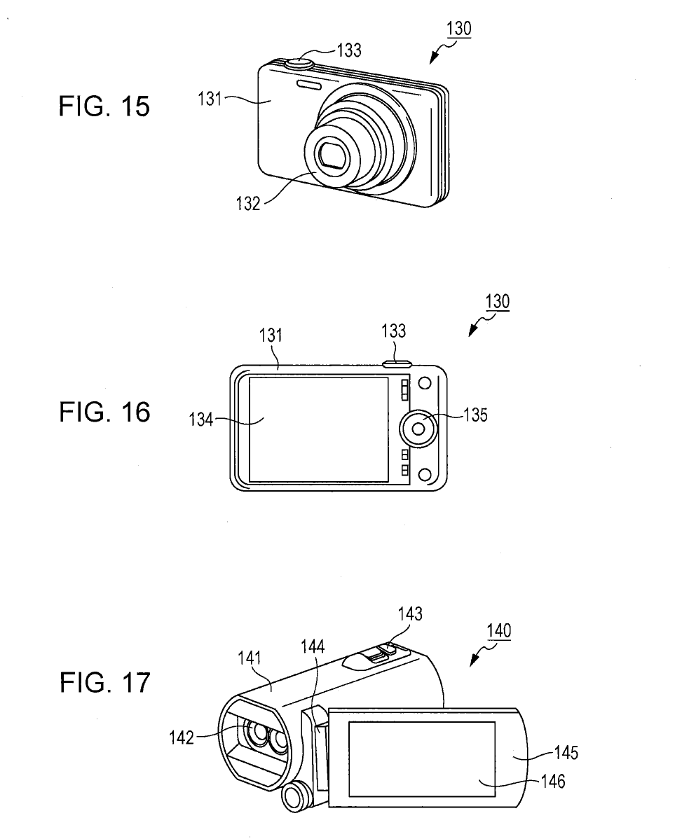

As illustrated in FIG. 15, on one face side of a casing 131 of a digital still camera 130, a lens 132 capturing an imaging target and an imaging button 133 used to allow an image to be captured in the digital still camera 130 are formed. Further, as illustrated in FIG. 16, on the other face side of the casing 131, a display section 134 that includes the display device 10 described above and a manipulation button 135 are mounted.

As illustrated in FIG. 17, a lens 142 and a manipulation button 143 are mounted in a casing 141 of a digital video camera 140. Further, a casing for a display section 145 is connected to the casing 141 through a connecting portion 144, and a display section 146 that includes the display device 10 described above is mounted in the casing for a display section 145.

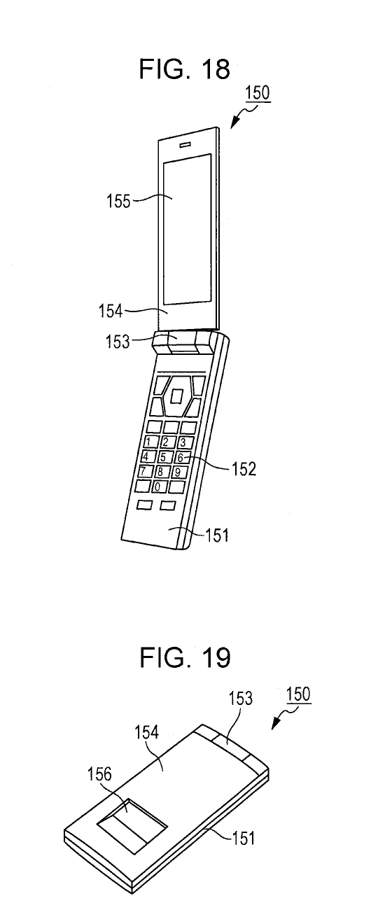

As illustrated in FIG. 18, manipulation buttons 152 are mounted in a lower casing 151 of a mobile phone unit 150, and an upper casing 154 is connected to the lower casing 151 through a connecting portion 153. A display section 155 that includes the display device 10 described above is mounted in the upper casing 154. Further, as illustrated in FIG. 19, a back side display section 156 that includes the display device 10 described above is mounted on a face opposite to the display section 155 in the upper casing 154.

In addition, display devices, display driving methods and electronic apparatus according to embodiments of the present disclosure can be configured as follows.
(1) A display device including: a plurality of pixel circuits; and a scanning line driving circuit that supplies control signals to the plurality of pixel circuits through scanning lines, wherein the scanning line driving circuit includes a voltage supply circuit that supplies a control potential, and an output buffer that generates the control signal by switching between a reference potential and the control potential, and the voltage supply circuit increases a difference between the control potential and the reference potential as operating temperature increases.
(2) The display device according to the above (1), wherein the voltage supply circuit includes a first power supply that supplies a first potential higher than the control potential, a second power supply that supplies a second potential lower than the control potential, and a resistance division circuit that is connected between the first power supply and the second power supply, and the resistance division circuit includes a diode-connected transistor and a resistor element.
(3) The display device according to the above (2), wherein the control potential is higher than the reference potential and the second potential is equal to the reference potential.
(4) The display device according to the above (2), wherein the control potential is higher than the reference potential and the second potential is equal to the reference potential.
(5) The display device according to any one of the above (2) to (4), wherein the voltage supply circuit has an output end between the transistor and the resistor element.
(6) The display device according to any one of the above (2) to (5), wherein in the voltage supply circuit, ON resistance of the transistor is larger than a resistance value of the resistor element, and the voltage supply circuit generates the control potential by resistance division of the resistor element and the transistor.
(7) The display device according to any one of the above (1) to (6), wherein the amplitude of the control signal when operating temperature is high is larger than the amplitude when the operating temperature is low.
(8) The display device according to any one of the above (1) to (7), wherein the output buffer includes a plurality of inverter circuits, and an inverter circuit that is connected to the scanning line, among the plurality of inverter circuits, is connected to the voltage supply circuit.
(9) The display device according to any one of the above (1) to (8), wherein the voltage supply circuit and the output buffer are formed on the same substrate.
(10) The display device according to any one of the above (1) to (9), further including: a signal line driving circuit that supplies display signals to the plurality of pixel circuits through signal lines, wherein the pixel circuit includes a sampling transistor, a transistor for driving, a light-emitting element, and a storage capacitor, the sampling transistor is connected to the signal line and the storage capacitor, and allows conduction according to the control signal, thereby writing a signal potential of the display signal to the storage capacitor, and the transistor for driving is connected between a power supply line and the light-emitting element and supplies a drive current to the light-emitting element according to a potential written to the storage capacitor.
(11) A display device including: a plurality of pixel circuits; and a scanning line driving circuit that supplies control signals to the plurality of pixel circuits through scanning lines, wherein the scanning line driving circuit includes an output buffer that outputs the control signal, a voltage supply circuit that supplies a control potential to a control potential line, and a reference potential line that supplies a reference potential, the output buffer is connected to the control potential line and the reference potential line, the voltage supply circuit includes a first power supply that supplies a first potential higher than the control potential, a second power supply that supplies a second potential lower than the control potential, and a resistance division circuit that is connected between the first power supply and the second power supply, and the resistance division circuit includes a diode-connected transistor and a resistor element.
(12) A display device comprising: a plurality of pixel circuits; and a scanning line driving circuit that supplies control signals to the plurality of pixel circuits through scanning lines, the scanning line driving circuit generating a control signal that transitions between a reference potential and a control potential, the control potential being altered dependent upon a temperature condition.
(13) The display device according to (12), wherein altering the control potential reduces differences in a transition of the control signal from the reference potential to the control potential that would occur with changes in the temperature condition.
(14) The display device according to (13), wherein reducing differences in the transition comprises reducing differences in a voltage rising period of the control signal as it transitions between the reference potential and the control potential.
(15) The display device according to (13), wherein the control potential increases as operating temperature increases to reduce differences in the transition of the control signal from the reference potential to the control potential that would occur with the operating temperature increases.
(16) The display device according to (12), wherein the scanning line driving circuit includes a voltage supply circuit that supplies the control potential, and an output buffer that generates the control signal by switching between the reference potential and the control potential.
(17) The display device according to (16), wherein the voltage supply circuit includes at least one circuit element having a resistive value that depends upon temperature connected between a first potential and a second potential, and the control potential is a function of the first potential and the resistive value.
(18) The display device according to (17), wherein the first potential is provided from a first power supply line, the second potential is provided from a second power supply line, the resistive value that depends upon temperature is provided by a diode-connected transistor having a gate and first current terminal connected to the second power supply line, a fixed resistive element is connected between a node and the first power supply line, and the control potential is provided from the node, the node being between a second current terminal of the diode-transistor and the fixed resistive element.
(19) The display device according to (12), wherein respective pixel circuits include: a drive transistor; a sampling transistor; and a storage capacitor, wherein the drive transistor is configured to provide current to a light emitting element according to an image signal voltage imparted to the storage capacitor through the sampling transistor, the control signal is provided to a control terminal of the sampling transistor, and altering the control potential reduces differences in a transition of the control signal from the reference potential to the control potential that would occur with changes in the temperature condition.
(20) The display device according to (19), further comprising correcting for a characteristic of the drive transistor, and wherein reducing differences in the transition of the control signal provides a consistent correction for the characteristic of the drive transistor over a range of temperatures.
(21) The display device according to (12), wherein the control potential is a write potential.
(22) The display device according to (19), wherein altering the control potential reduces differences in a transition of the control signal from the reference potential to the control potential that would occur with changes in the temperature condition.
(23) The display device according to (22), wherein reducing differences in the transition comprises reducing differences in a voltage rising period of the control signal as it transitions between the reference potential and the control potential.
(24) The display device according to (22), wherein the control potential increases as operating temperature increases to reduce differences in the transition of the control signal from the reference potential to the control potential that would occur with the operating temperature increases.
(25) The display device according to (19), wherein the scanning line driving circuit includes a voltage supply circuit that supplies the control potential, and an output buffer that generates the control signal by switching between the reference potential and the control potential.
(26) The display device according to (25), wherein the voltage supply circuit includes at least one circuit element having a resistive value that depends upon temperature connected between a first potential and a second potential, and the control potential is a function of the first potential and the resistive value.
(27) An electronic apparatus comprising the display device of (12).
(28) A display device comprising: a plurality of pixel circuits; and a scanning line driving circuit that supplies control signals to the plurality of pixel circuits through scanning lines,
wherein the scanning line driving circuit includes: an output buffer that outputs the control signal,
a voltage supply circuit that supplies a control potential to a control potential line, and a reference potential line that supplies a reference potential, the output buffer being connected to the control potential line and the reference potential line, and the voltage supply circuit includes: a resistance division circuit that is connected between a first power supply line and a second power supply line, the first power supply line providing a first potential that is higher than the control potential, and second power supply line providing a second potential that is lower than the control potential, the resistance division circuit including a diode-connected transistor and a resistor element.
(29) A method for driving a display device including a plurality of pixel circuits and a scanning line driving circuit, the method comprising: supplying, by the scanning line driving circuit, control signals to the plurality of pixel circuits through scanning lines, by generating a control signal that transitions between a reference potential and a control potential, the control potential being altered dependent upon a temperature condition.

The present disclosure contains subject matter related to that disclosed in Japanese Priority Patent Application JP 2012-105250 filed in the Japan Patent Office on May 2, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a plurality of pixel circuits; and
a scanning line driving circuit that supplies control signals to the plurality of pixel circuits through scanning lines, the scanning line driving circuit generating a control signal that transitions between a reference potential and a control potential, the control potential being altered dependent upon a temperature condition.

2. The display device according to claim 1, wherein altering the control potential reduces differences in a transition of the control signal from the reference potential to the control potential that would occur with changes in the temperature condition.

3. The display device according to claim 2, wherein reducing differences in the transition comprises reducing differences in a voltage rising period of the control signal as it transitions between the reference potential and the control potential.

4. The display device according to claim 2, wherein the control potential increases as operating temperature increases to reduce differences in the transition of the control signal from the reference potential to the control potential that would occur with the operating temperature increases.

5. The display device according to claim 1, wherein the scanning line driving circuit includes a voltage supply circuit that supplies the control potential, and an output buffer that generates the control signal by switching between the reference potential and the control potential.

6. The display device according to claim 5, wherein the voltage supply circuit includes at least one circuit element having a resistive value that depends upon temperature connected between a first potential and a second potential, and the control potential is a function of the first potential and the resistive value.

7. The display device according to claim 6, wherein the first potential is provided from a first power supply line, the second potential is provided from a second power supply line, the resistive value that depends upon temperature is provided by a diode-connected transistor having a gate and first current terminal connected to the second power supply line, a fixed resistive element is connected between a node and the first power supply line, and the control potential is provided from the node, the node being between a second current terminal of the diode-transistor and the fixed resistive element.

8. The display device according to claim 1, wherein respective pixel circuits include:
a drive transistor;
a sampling transistor; and
a storage capacitor,
wherein the drive transistor is configured to provide current to a light emitting element according to an image signal voltage imparted to the storage capacitor through the sampling transistor,
the control signal is provided to a control terminal of the sampling transistor, and
altering the control potential reduces differences in a transition of the control signal from the reference potential to the control potential that would occur with changes in the temperature condition.

9. The display device according to claim 8, further comprising correcting for a characteristic of the drive transistor, and wherein reducing differences in the transition of the control signal provides a consistent correction for the characteristic of the drive transistor over a range of temperatures.

10. The display device according to claim 1, wherein the control potential is a write potential.

11. The display device according to claim 8, wherein altering the control potential reduces differences in a transition of the control signal from the reference potential to the control potential that would occur with changes in the temperature condition.

12. The display device according to claim 11, wherein reducing differences in the transition comprises reducing differences in a voltage rising period of the control signal as it transitions between the reference potential and the control potential.

13. The display device according to claim 11, wherein the control potential increases as operating temperature increases to reduce differences in the transition of the control signal from the reference potential to the control potential that would occur with the operating temperature increases.

14. The display device according to claim 8, wherein the scanning line driving circuit includes a voltage supply circuit that supplies the control potential, and an output buffer that generates the control signal by switching between the reference potential and the control potential.

15. The display device according to claim 14, wherein the voltage supply circuit includes at least one circuit element having a resistive value that depends upon temperature connected between a first potential and a second potential, and the control potential is a function of the first potential and the resistive value.

16. An electronic apparatus comprising the display device of claim 1.

17. A display device comprising:
a plurality of pixel circuits; and
a scanning line driving circuit that supplies control signals to the plurality of pixel circuits through scanning lines,
wherein the scanning line driving circuit includes:
an output buffer that outputs the control signal,
a voltage supply circuit that supplies a control potential to a control potential line, and
a reference potential line that supplies a reference potential, the output buffer being connected to the control potential line and the reference potential line,
and the voltage supply circuit includes:
a resistance division circuit that is connected between a first power supply line and a second power supply line, the first power supply line providing a first potential that is higher than the control potential, and second power supply line providing a second potential that is lower than the control potential, the resistance division circuit including a diode-connected transistor and a resistor element.

18. A method for driving a display device including a plurality of pixel circuits and a scanning line driving circuit, the method comprising:
supplying, by the scanning line driving circuit, control signals to the plurality of pixel circuits through scanning lines, by generating a control signal that transitions between a reference potential and a control potential, the control potential being altered dependent upon a temperature condition.
